(19) United States
(12) Patent Application Publication
(10) Pub. No.: US 2024/0009846 A1
(43) Pub. Date: Jan. 11, 2024

(54) CONTROL METHOD

(71) Applicant: SEIKO EPSON CORPORATION, Tokyo (JP)

(72) Inventors: Fuyumi TAKATA, AZUMINO-SHI (JP); Eiji INOMATA, MATSUMOTO-SHI (JP); Yuki KOBARI, MATSUMOTO-SHI (JP)

(21) Appl. No.: 18/218,125

(22) Filed: Jul. 5, 2023

(30) Foreign Application Priority Data
Jul. 7, 2022 (JP) 2022-109654

(51) Int. Cl. B25J 9/16; B25J 19/00

(52) U.S. Cl. CPC B25J 9/1674; B25J 19/00

(57) ABSTRACT

A control method for controlling a robot includes a measuring step of measuring a temperature of measurement target of drive mechanisms from among a plurality of the drive mechanisms at predetermined time intervals by a temperature sensor included in a temperature control device, a heating step of heating the plurality of the drive mechanisms by heaters included in the temperature control device, a stopping step of stopping an operation of the plurality of the drive mechanisms by a robot controller, when the temperature of the measurement target falls below a set stop temperature, and a resuming step of resuming the operation of the plurality of drive mechanisms when the temperature of the measurement target is equal to or higher than a set resume temperature after the robot controller 500 has performed the stopping step.

### CROSS-REFERENCE TO RELATED APPLICATIONS

The present application is based on, and claims priority from JP Application Serial Number 2022-109654, filed Jul. 7, 2022, the disclosure of which is hereby incorporated by reference herein in its entirety.

### BACKGROUND

### 1. Technical Field

The present disclosure relates to a control method fora robot arm.

### 2. Related Art

There is a demand to have a robot arm perform work instead of humans in low-temperature environments such as a frozen food production lines, which are relatively harsh environments for humans to work in. JP-A-08-019978 describes technology for a robot arm used in low-temperature environments. In the technology described in JP-A-08-019978, it is described that if the temperature of joints of the robot arm drops to near the lower limit of an allowable operation temperature during the operation of robot arm, the joints are heated by a heater.

However, in the technology described in JP-A-08-019978, the temperature of the joints of the robot arm remains low for a while after heating by the heater is started. Therefore, it is considered that the power consumption of the robot arm operation unnecessarily increases due to hardening of the lubricant used in the joints, or the motor that or drives the joints may fail due to the occurrence of dew condensation inside the robot arm.

### SUMMARY

According to an aspect of the present disclosure, a control method for controlling a robot arm in a robot system is provided, the robot system has a robot arm including a plurality of joints and a plurality of drive sections that drive each of the plurality of joints, a controller that controls the robot arm, and a temperature control section that includes a temperature measurement section and a heating section and that adjusts a temperature of the robot arm. The control method includes a measuring step of measuring a temperature of a measurement target drive section from among the plurality of drive sections, at a predetermined time interval using the temperature measurement section; a heating step of heating the plurality of drive sections using the heating section; a stopping step of the controller stopping operation of the plurality of drive sections when the temperature of measurement target falls below a preset stop temperature; and a resuming step of the controller, after performing the stopping step, resuming operation of the plurality of drive sections when the temperature of measurement target is equal to or higher than a preset resume temperature.

### BRIEF DESCRIPTION OF THE DRAWINGS

FIG. 1 is a schematic diagram showing an overall configuration of a robot system.

FIG. 2 is a block diagram showing main parts of a robot and a robot controller.

FIG. 3 is an exploded perspective view of an arm element.

FIG. 4 is a partial cross-sectional view of the arm element when cut at a 4-4 cut line shown in FIG. 3.

FIG. 5 is a side view of the arm element shown in FIG. 3.

FIG. 6 is a side view of the arm element shown in FIG. 3 seen from another direction.

FIG. 7 is a flowchart of a control process.

### DESCRIPTION OF EMBODIMENT

### A1. Embodiment

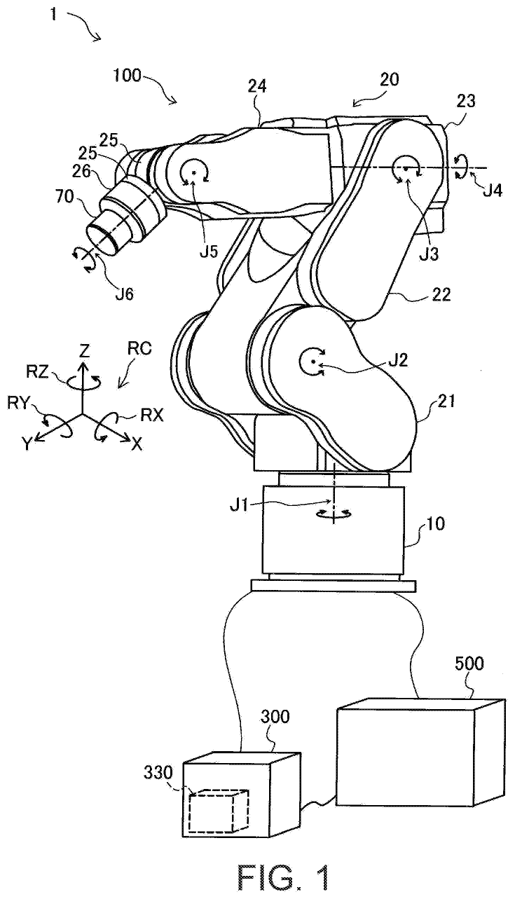

FIG. 1 is a schematic diagram showing an overall configuration of a robot system 1 according to this embodiment. The robot system 1 has a robot 100, a temperature control device 300 that adjusts the temperature of the robot 100, and a robot controller 500 that controls the robot 100. The robot 100 is also referred to as a robot arm. The temperature control device 300 is also called a temperature control section. The robot 100 is a vertically articulated robot. The robot 100 performs work related to food production in a food factory. In this embodiment, the robot 100 will be installed in a low-temperature environment and will perform work in the low-temperature environment. The low-temperature environment refers to an environment of 10° C. or lower, such as inside of a refrigerator in a refrigerated warehouse, and in particular, in this specification, an environment of −18° C. or lower, such as inside of a freezer in a cold storage warehouse. It is assumed that the temperature control device 300 and the robot controller 500 are installed in a normal temperature environment. In this specification, a normal temperature environment is defined in this specification as an environment in the range of 15 to 25° C., such as outside the refrigerator of refrigerated warehouse or outside the freezer of cold storage warehouse.

The robot controller 500 is connected to the arm 20 and the end effector 70 of the robot via signal lines. The robot controller 500 controls the positions of the control points of the robot 100 in the robot coordinate system RC. The control point of the robot 100 is set, for example, at the center of a point where the end effector 70 touches a target object. The control point may be referred to as a tool center point (TCP). The robot controller 500 changes the position and posture of the robot 100 by driving the robot 100. Thus, the robot controller 500 can move the end effector 70, which is attached to the tip end of the arm 20 of the robot 100, to a designated position and in a designated posture. For example, the robot controller 500 can communicate with a control device (not shown), and controls the arm 20 and the end effector 70 of the robot 100 according to an operation command received from the control device. The control device is, for example, a programmable logic controller.

In this embodiment, a coordinate system that defines a space in which the robot 100 is installed, based on the position of the base 10, is represented as the robot coordinate system RC. The robot coordinate system RC is a three-dimensional Cartesian coordinate system defined by an X-axis and a Y-axis, which are orthogonal to each other in the horizontal plane, and a Z-axis, whose positive direction is upward in the vertical direction. An arbitrary position in the robot coordinate system RC can be represented by a position in the X-axis direction, a position in the Y-axis direction, and a position in the Z-axis direction. It will be assumed that an angular position of rotation around the X axis is RX, an angular position of rotation around the Y axis is RY, and an angular position of rotation around the Z axis is RZ. An arbitrary posture in the robot coordinate system RC can be represented by the angular position RX, the angular position RY, and the angular position RZ.

The robot 100 includes the base 10, the arm 20, and the end effector 70. The base 10 supports the components of the robot 100. By fixing the base 10 to the floor, the robot 100 is installed on the floor. Although not shown in FIG. 1, the robot 100 is powered by an external AC power source.

The arm 20 includes arm elements 21, 22, 23, 24, 25 and 26. Further, the arm 20 includes six joints J1 to J6. The joints J1 to J6 are rotational joints. The arm element 21 is connected to an upper end portion of the base 10. A connecting portion between the base 10 and the arm element 21 constitutes the joint J1. The arm element 21 rotates relative to the base 10 around a rotation axis of the joint J1. The arm element 22 is connected to a tip end portion of the arm element 21. A connecting portion between the arm element 21 and the arm element 22 constitutes the joint J2. The arm element 22 rotates relative to the arm element 21 around a rotation axis of the joint J2. The arm element 23 is connected to a tip end portion of the arm element 22. A connecting portion between the arm element 22 and the arm element 23 constitutes the joint J3. The arm element 23 rotates relative to the arm element 22 around a rotation axis of the joint J3. The arm element 24 is connected to a tip end portion of the arm element 23. A connecting portion between the arm element 23 and the arm element 24 constitutes the joint J4. The arm element 24 rotates relative to the arm element 23 around a rotation axis of the joint J4. The arm element 25 is connected to the end portion of the arm element 24. A connecting portion between the arm element 24 and arm element 25 constitutes the joint J5. The arm element 25 rotates relative to the arm element 24 around a rotation axis of the joint J5. The arm element 26 is connected to the tip end portion of the arm element 25. A connecting portion between the arm element 25 and arm element 26 constitutes the joint J6. The arm element 26 rotates relative to the arm element 25 around a rotation axis of the joint J6. The Joint J6 rotates around a rotation axis that is perpendicular to the rotation axis of the joint J5. Details of the configuration of the arm elements will be described later.

The end effector 70 is attached to the arm element 26 via a force sensor (not shown). The end effector 70 is, for example, a device for gripping a workpiece (not shown). In FIG. 1, the end effector 70 is shown as a cylindrical member to facilitate understanding of the technology. The end effector 70 is controlled by the robot controller 500.

The temperature control device 300 adjusts the temperature of the six drive mechanisms 40 that drive the joints J1 to J6 of the arm 20 of the robot 100. Specifically, the temperature control device 300 heats the six drive mechanisms 40 with corresponding heaters 320 to maintain the target temperature specified by the robot controller 500. The drive mechanism 40 is also referred to as a drive section. Six drive mechanisms 40 are also referred to as a plurality of drive sections. The temperature control device 300 can separately control the temperature of six points. The temperature control device 300 includes six temperature sensors 310, six heaters 320, and an adjustment section 330. The six heaters 320 and the adjustment section 330 are also referred to as a heating section. The six temperature sensors 310 and the adjustment section 330 are also referred to as a temperature measurement section. In FIG. 1, the six temperature sensors 310 and the six heaters 320 are not shown. The temperature control device 300 is connected to the robot controller 500 via signal lines. Although not shown in FIG. 1, the temperature control device 300 is powered from the external AC power source.

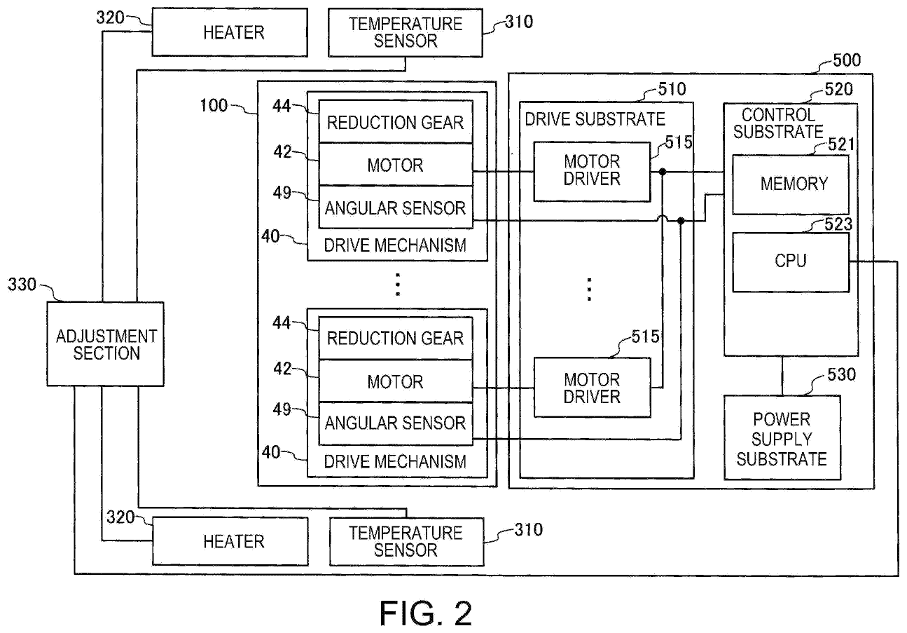

FIG. 2 is a block diagram showing main parts of the robot 100, the temperature control device 300, and the robot controller 500. Each of the drive mechanisms 40 is assigned one temperature sensor 310 and one heater 320. In FIG. 2, only two drive mechanisms 40, two temperature sensors 310, and two heaters 320 are shown. The temperature sensor 310 is, for example, a thermocouple or a resistance thermometer. The temperature sensor 310 measures the temperature in the vicinity of the corresponding drive mechanism 40. That is, a measuring step of measuring a temperature of measurement target, the drive mechanism 40, at predetermined time intervals is performed by the temperature control device 300. In this specification, measuring the temperature of the corresponding drive mechanism 40 by the temperature sensor 310 is assumed to include measuring the temperature in the vicinity of the corresponding drive mechanism 40 by the temperature sensor 310. In this embodiment, all of the six drive mechanisms 40 are assumed to be the measurement target. The heater 320 is, for example, a heater in which a heating element, a nichrome wire, is covered with a metal film. The heater 320 generates heat by suppling an electric current. The heater 320 heats the corresponding drive mechanism 40. That is, a heating step of heating the drive mechanism 40 is performed by the temperature control device 300. In this specification, heating of the corresponding drive mechanism 40 by the heater 320 is assumed to include heating of the vicinity of the corresponding drive mechanism 40 by the heater 320. The six temperature sensors 310 and the six heaters 320 are located at predetermined positions in the arm 20. Details of the location of the temperature sensors 310 and the heaters 320 are described later.

The adjustment section 330 controls a heating amount of each heater 320 so that the temperature of the drive mechanism 40 approaches a target temperature based on the temperature measured by the temperature sensor 310 for each of the six drive mechanisms 40. Controlling the heating amount of the heater 320 includes setting the heat amount to zero, that is, turning off the heater 320. The target temperature is a temperature for the drive mechanism 40 that is desired to be maintained. The adjustment section 330 controls the heating amount of the heater 320, for example, by proportional integral differential (PID) control to bring the measured temperature closer to the target temperature, that is, to match the deviation between the measured temperature and the target temperature to the value 0. The ambient temperature at which the robot 100 can operate normally is assumed to be 0 to 45° C. in this specification. The target temperature is desirable to be in a range of ambient temperature at which the robot 100 can operate normally. For example, the target temperature is 10° C. Here, the heating amount of the heater 320 is the heating amount per unit of time. In addition, the adjustment section 330 outputs the measured values of the temperatures measured by the six temperature sensors 310 to a control substrate 520 of the robot controller 500 at predetermined time intervals.

The robot controller 500 has a drive substrate 510, the control substrate 520, and a power supply substrate 530. The drive substrate 510 has six motor drivers 515. Each motor driver 515 drives the motor 42 of the corresponding drive mechanism of the six drive mechanisms 40. The drive substrate 510 drives the six motors 42 under the control of the control substrate 520. The drive substrate 510 is located inside the arm 20.

The control substrate 520 has a memory 521 and a central processing unit (CPU) 523. The memory 521 stores programs and data used in various processes performed by the robot controller 500. For example, the memory 521 stores an operation program that controls the operation of the robot 100, and the target temperature values for each of the six drive mechanisms 40. The CPU 523 realizes various functions by executing the programs stored in the memory 521.

For example, the CPU 523 sets the target values indicating the target temperatures for each of the six drive mechanisms 40 in the adjustment section 330 of the temperature control device 300. In this embodiment, the target temperatures of the six drive mechanisms 40 are assumed to be the same.

The power supply substrate 530 converts power supplied from the external AC power source into DC power, and supplies the converted power to the control substrate 520. The power supply substrate 530 has a circuit that steps down the power supplied from the external AC power source and converts the stepped down power to the DC power. The control substrate 520 and the power supply substrate 530 are located inside the housing of the robot controller 500.

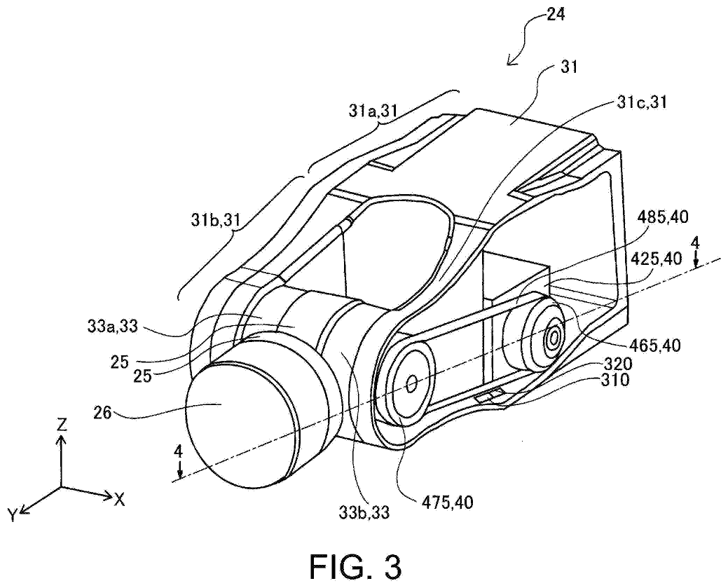

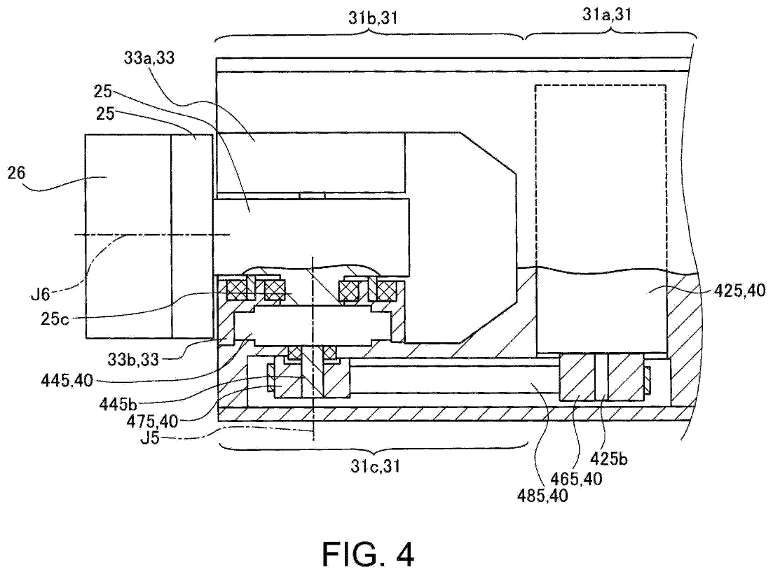

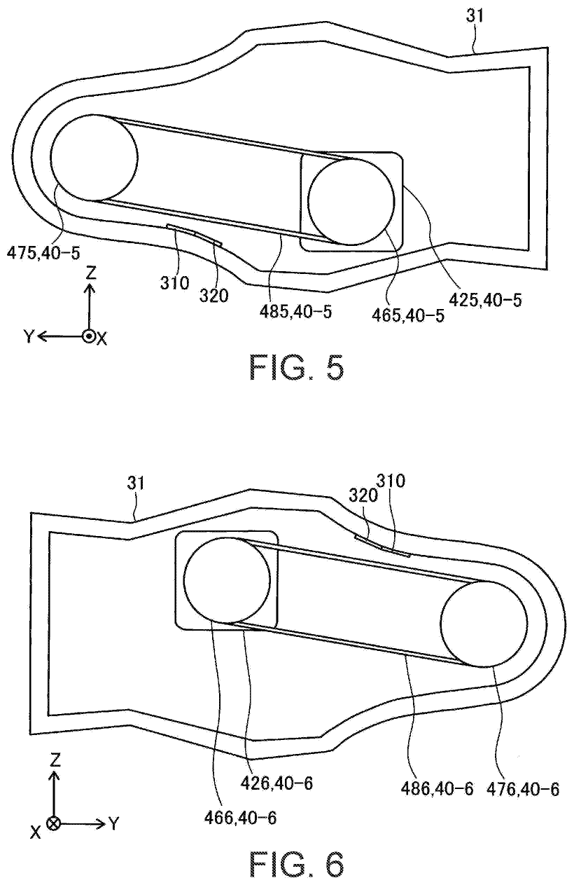

FIG. 3 is an exploded perspective view of the arm element 24. In order to facilitate understanding of the technology, some of the configurations provided by the arm element 24 are omitted in FIG. 3. FIG. 4 is a partial cross-sectional view of the arm element 24 when taken along the cut line 4-4 shown in FIG. 3. In FIG. 3 and FIG. 4, the end effector 70 is omitted. FIG. 5 is a side view of the arm element 24 shown in FIG. 3 when viewed in the −X direction. FIG. 5 shows a side view of the arm element 24 in a state where the +X side surface of a main body 31 of the arm element 24 has been removed. In FIG. 5, the other components are omitted in order to show the relationship of the positions of the motor 425, the first pulley 465, the second pulley 475, and the belt 485. In FIG. 3 to FIG. 6, a Cartesian coordinate system, which is different from the robot coordinate system RC, is set for convenience. The Cartesian coordinate system set up in FIG. 3 to FIG. 6 is a fixed coordinate system for the arm element 24.

The arm element 24 has the main body 31, a connection member 33, and the drive mechanism 40. The main body 31 is a hollow housing made of aluminum or an aluminum alloy. As shown in FIG. 3 and FIG. 4, in the arm element 24, the main body 31 includes a base section 31a, a first tip section 31b, and a second tip section 31c. The first tip section 31b and the second tip section 31c are formed to extend from the base section 31a to the +Y direction. The shape of the main body 31 of the arm elements, other than the arm element 24, is configured in a shape depending on the joint located in each arm element.

The connection member 33 is a member that connects the arm element 24 and the arm element 25. In the arm element 24, the connection member 33 has a cylindrical member 33a and a cylindrical member 33b. The arm element 25 is located between the first tip section 31b and the second tip section 31c. The cylindrical member 33a is disposed between the first tip section 31b and the arm element 25. The cylindrical member 33a is fixed to the first tip section 31b by being fitted into an opening formed in a side surface on the +X side of the first tip section 31b. The cylindrical member 33b is located between the second tip section 31c and the arm element 25. The cylindrical member 33b is fixed to the second tip section 31c by being fitted into an opening formed in a side surface on the −X side of the second tip section 31c.

The first tip section 31b and the second tip section 31c, and the cylindrical members 33a and 33b constitute a joint structure. The arm element 25 is sandwiched between the cylindrical members 33a and 33b, whereby the arm element 25 is held by the arm element 24. The arm element 25 is rotatable in the position where it is disposed. The number and respective shapes of the members constituting the connection member 33 of the arm element, other than the arm element 24, are configured depending on the joint located in that arm element.

Each drive mechanism 40 drives the corresponding joint among the joint J1 to joint J6. The drive mechanism 40 having the arm element 24 is sometimes referred to as a drive mechanism 40-5. The drive mechanism 40-5 drives the joint J5. The drive mechanism 40 (drive mechanism 40-5) that drives the joints J5 has a motor 425, a reduction gear 445, a first pulley 465, a second pulley 475, a belt 485, and an angular sensor 495. The motor 425 is the motor 42 that is provided in the drive mechanism 40-5. The reduction gear 445 is the reduction gear 44 that is provided in the drive mechanism 40-5. The angular sensor 495 is the angular sensor 49 that is provided in the drive mechanism 40-5. The reduction gear 445 and the angular sensor 495 are omitted in FIG. 3. In FIG. 4, the internal structure of the motor 425 and of the reduction gear 445, and the angular sensor 495 are omitted.

The motor 425 rotates a rotation axis 425b under the control of the robot controller 500 to drive the joint J5. The motor 425 is, for example, a servomotor. The reduction gear 445 converts a rotational input from the motor 425 into a rotational output with a lower rotational speed. The first pulley 465 is connected to the rotation axis 425b of the motor 425. The second pulley 475 is connected to a shaft section 445b of the reduction gear 445. As shown in FIG. 4, the reduction gear 445 is connected to a shaft section 25c, which is integrally formed with the arm element 25. As shown in FIG. 3 and FIG. 5, the belt 485 is wound between the first pulley 465 and the second pulley 475. Therefore, the rotational force of the motor 425 can be transmitted to the arm element 25.

As shown in FIG. 2, the angular sensor 49 (495) detects the angular position of the output axis of the motor 425 as the rotational angle of the joint J5, and outputs the detected value to the control substrate 520 of the robot controller 500. The angular sensor 49 is, for example, a rotary encoder. In addition, the angular sensor 49 is a battery-less encoder that does not require a battery to store and hold the detected value, and is, for example, a battery-less encoder with a multiple gear structure. Specifically, the angular sensor 49 has a main-shaft gear that is attached to the output shaft of the motor 425 and a first through third sub-shaft gears that mesh with the main-shaft gear, and the number of teeth of those four gears is an integer that has no greatest common divisor other than 1. From the combination of these four gears positions, the angular sensor 49 determines the angular position within one rotation and how many rotations have been made, then detects this as an angle of rotation. The angular sensor 49 may be another battery-less encoder, for example, a battery-less encoder that holds the detected value in a memory by a power generating device using magnetic or motive force.

Each of the arm elements 21 to 23, as well as the arm element 24, has the main body 31, the connection member 33, and the drive mechanism 40. The drive mechanism 40 of the arm element 21 drives the joint J2. The drive mechanism 40 of the arm element 22 drives the joint J3. The drive mechanism 40 of the arm element 23 drives the joint J4. The drive mechanism 40 that drives the joint J1 is located inside the base 10.

In addition, the drive mechanism 40 is not provided inside the arm element 26. Therefore, in addition to the drive mechanism 40 that drives the joint J5, another drive mechanism 40 that drives the joint J6 is provided inside the arm element 24.

FIG. 6 is a side view of the arm element 24 shown in FIG. 3 when viewed in the +X direction. FIG. 6 is a side view of the arm element 24 with the −X side surface of the main body 31 removed. The drive mechanism 40 for driving the joint J6 is shown in FIG. 6. The drive mechanism 40 for driving the joint J6 may be referred to as a drive mechanism 40-6. The drive mechanism 40 (40-6) that drives the joint J6 has a motor 426, a reduction gear 446, a first pulley 466, a second pulley 476, a belt 486, and an angular sensor 496. The motor 426 is the motor 42 that is provided in the drive mechanism 40-6. The reduction gear 446 is the reduction gear 44 that is provided in the drive mechanism 40-6. The angular sensor 496 is the angular sensor 49 that is provided in the drive mechanism 40-6. To show the relationship of the positions of the motor 426, the first pulley 466, the second pulley 476, and the belt 486, other components are omitted from FIG. 6. The joint J6 rotates about a rotation axis that intersects the rotation axis of the motor 426. Therefore, the reduction gear 446 has a bevel gear, such as a hypoid gear or a worm gear, and converts the rotational direction of the power transmitted from the motor 426 to a substantially vertical direction. In addition, the reduction gear 446 reduces the rotational speed of the power input from the motor 426.

Next, positions where the temperature sensor 310 and the heater 320 of the temperature control device 300 are installed will be described. As shown in FIG. 3 and FIG. 5, in the arm element 24, the temperature sensors 310 and the heaters 320 for the drive mechanisms 40 (drive mechanisms 40-5) that drive the joint J5 are located on the inside surface of the bottom surface of the main body 31, in between the motor 425 and the reduction gears 445. For example, the temperature sensor 310 and the heater 320 are located at an intermediate point of a straight line connecting the motor 425 and the reduction gear 445.

As described above, the main body 31 is formed of aluminum or an aluminum alloy. Thus, the heat generated by the heater 320 is conducted through the main body 31. As a result, the motor 425 and the reduction gear 445 are heated.

Further, as shown in FIG. 6, in the arm element 24, the temperature sensor 310 and the heater 320 for the drive mechanism 40 (drive mechanism 40-6) that drive the joint J6 are located on the inside surface of the upper surface of the main body 31, between the motors 426 and the reduction gear 446. For example, the temperature sensor 310 and the heater 320 are located at an intermediate point of a straight line connecting the motor 426 and the reduction gear 446. The heat generated by the heater 320 is conducted through the main body 31. As a result, the motor 426 and the reduction gear 446 are heated.

In addition, the temperature sensor 310 and the heater 320 for the drive mechanism 40 that drives the joint J1 are located on the inside wall surface of the base 10, which is inside the base 10 and is between the motor 42 and the reduction gear 44. The temperature sensor 310 and the heater 320 for the drive mechanism 40 that drives the joint J2 are located on the inside surface of the main body of the arm element 21, which is inside the main body of the arm element 21 and is between the motor 42 and the reduction gear 44. The temperature sensor 310 and the heater 320 for the drive mechanism 40 that drives the joint J3 are located on the inside surface of the main body of the arm element 22, which is inside the main body of the arm element 22 and is between the motor 42 and the reduction gear 44. The temperature sensor 310 and the heater 320 for the drive mechanism 40 that drives the joint J4 are located on the inside surface of the main body of the arm element 23, which is inside the main body of the arm element 23 and is between the motor 42 and the reduction gear 44.

As described above, the temperature sensor 310 and the heater 320 are provided in the drive mechanisms 40 that drive each joint. The temperature control device 300 separately controls the heating amount of the heaters 320 so that for each drive mechanism 40 the measured temperature approaches the target temperature, that is, so that the deviation between the measured temperature and the target temperature approaches the value 0.

In the robot system 1 having the above configuration, a method of controlling the temperature of the robot 100 will be described below.

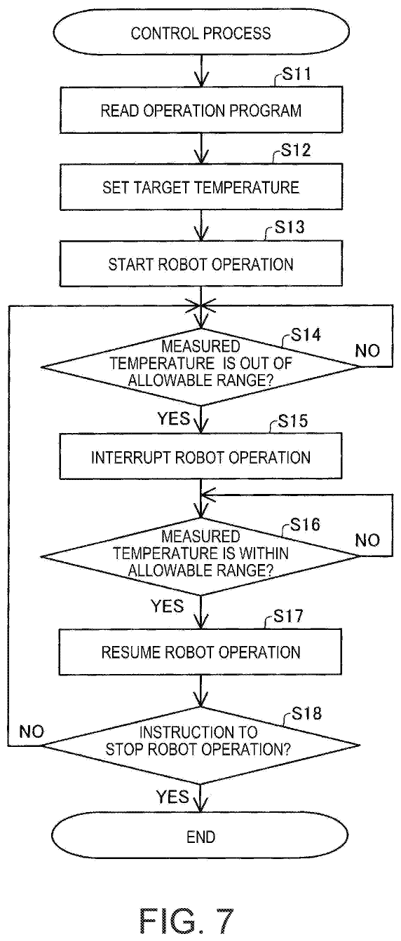

FIG. 7 is a flowchart of a control process for controlling the robot 100. The temperature control process is executed by the central processing unit (CPU) 523 of the control substrate 520, which is provided in the robot controller 500. It is assumed that the power of the temperature control device 300 is turned on in advance. For example, it is assumed that default values are set as each target temperature when the temperature control device 300 is turned on. When the temperature control device 300 is turned on, the temperature control device 300 starts adjusting the temperature of each drive mechanism 40 by controlling the heating amount of the six heaters 320 so that measured values approach the default values of the target temperature.

In step S11, the CPU 523 reads the operation program stored in the memory 521. The operation program is a program that controls the operation of the robot 100.

In step S12, the CPU 523 reads out the target values indicating the target temperatures from the memory 521. In order to set the target values read out to the adjustment section 330 of the temperature control device 300, the CPU 523 sends a command including the target values to the temperature control device 300. The temperature control device 300 adjusts the temperature of each of the six drive mechanisms 40 to approach the new target values that have been set. Further, the temperature control device 300 outputs the measured temperature values measured by the six temperature sensors 310 to the control substrate 520 of the robot controller 500 at predetermined time intervals. In addition, the CPU 523 reads out an upper limit value and a lower limit value, indicating the allowable temperature range of the drive mechanisms 40, from the memory 521. The lower limit value is also called a stop temperature. The lower limit value is also called a resume temperature. The lower limit value is, for example, 5° C., which is set higher than 0° C., which is the temperature at which the lubricant tends to harden. The upper limit value is 70° C., for example, which is set at the upper limit of the temperature that the robot 100 can normally withstand. The CPU 523 may execute step 13 after waiting a preset period of time after executing step S12. In this way, the robot 100 can start to operate after the temperature of the arm 20 of the robot 100 has risen to some degree.

In step S13, the CPU 523 executes the operation program to start the operation of the robot 100.

In step S14, if at least one of the six measured temperatures output from the temperature control device 300 is outside an allowable range (step S14; YES), the CPU 523 executes step S15. The allowable range is the range above the lower limit value and below the upper limit value.

On the other hand, if none of the six measured temperatures is outside the allowable range, that is, all six measured temperatures are within the allowable range (step S14; NO), the CPU 523 waits for a preset time to elapse and then executes step S14 again. In this embodiment, the stop condition where the operation of the drive mechanism 40 is stopped, shall include cases where the temperatures of the six drive mechanisms 40 of the measurement target are below the lower limit value of the allowable range and cases where the temperatures are above the upper limit value of the allowable range.

In step S15, the CPU 523 stops all the drive mechanisms 40. Therefore, the operation of the robot 100 is interrupted. In other words, the stopping step, which stops the operation of the drive mechanism 40 when the temperature of the measurement target becomes below the preset stop temperature, is performed by the robot controller 500.

In step S16, if all of the six measured temperatures output from the temperature control device 300 are within the allowable range (step S16; YES), the CPU 523 executes step S17. In this embodiment, the resume condition in which the operation of the drive mechanism 40 is resumed includes a condition that the temperatures of the six drive mechanisms 40 to be measured are equal to or higher than the lower limit value of the allowable range and are equal to or lower than the upper limit value of the allowable range.

On the other hand, if at least one of the six measured temperatures output from the temperature control device 300 is not within the allowable range (step S16; NO), the CPU 523 waits for a preset time to elapse, and then performs step S16 again.

In step S17, the CPU 523 resumes the operation of the robot 100. That is, after the operation of the drive mechanism 40 is stopped, when the temperature of the measurement target is equal to or higher than the preset resume temperature, the resuming step of resuming the operation of the drive mechanism 40 is performed by the robot controller 500. After that, the CPU 523 executes step S18.

In step S18, if the CPU 523 has not received an instruction to stop the operation of the robot 100 (step S18; NO), the CPU 523 executes step S14 again. For example, the robot controller 500 receives the instruction to stop the operation of the robot 100 from the control device (not shown). On the other hand, if the CPU 523 receives an instruction to stop the operation of the robot 100 (step S18; YES), the control process is finished.

As described above, in this embodiment, when the temperature of the measurement target, which is the drive mechanism 40, becomes below the lower limit value, then the operation of all the drive mechanisms 40 are stopped. Therefore, the robot 100 does not continued to operate while the temperature of the drive mechanism 40 of the robot 100 remains low. Therefore, hardening of the lubricant and dew condensation inside the robot 100 can be suppressed during the robot 100 operation. Accordingly, it is possible to suppress an unnecessary increase in power consumption of the robot arm operation due to hardening of the lubricant and failure of the motor that drives the joints due to dew condensation inside the robot arm.

Further, after the operations of the drive mechanisms 40 are stopped, when the temperatures of all the drive mechanisms 40 reach or exceed the lower limit value, the operations of all the drive mechanisms 40 are resumed. Therefore, the lubricant does not harden and the robot 100 can operate smoothly. This can also prevent problems such as the failure of the motor 42 due to dew condensation inside the robot 100.

When the temperature of at least one of the six drive mechanisms 40 of the robot 100 is below the lower limit value, that is, below the stop temperature, the operation of the six drive mechanisms 40 is stopped. Therefore, it is possible to more certainly suppress the occurrence of hardening of the lubricant, dew condensation inside the robot arm, and the like, during the operation of the robot 100.

Further, after the drive mechanisms 40 are stopped, when the temperature of each of the six drive mechanisms 40 is equal to or higher than the lower limit value, that is, equal to or higher than the resume temperature, operations of the six drive mechanisms 40 are resumed. Since operations of the drive mechanisms 40 are not resumed until the temperatures of all of the drive mechanisms 40 of the robot 100 become equal to or higher than the lower limit value, the occurrence of hardened lubricant, dew condensation inside the robot arm, and the like, can be more certainly suppressed during the operation of the robot 100.

### B1. Other Embodiment 1

In this embodiment, even after CPU 523 of the robot controller 500 stops all the drive mechanisms 40 (see step S15 in FIG. 7), the motor driver 515 of the drive substrate 510 still energizes to the drive mechanisms 40. However, after stopping all the drive mechanisms 40, the CPU 523 of robot controller 500 may further control the drive substrate 510 so as to shut off energization to the drive mechanisms 40 from the motor driver 515 of the drive substrate 510. For example, the CPU 523 turns off a switching element of an inverter contained in the motor driver 515 of the drive substrate 510 to shut off energization to the drive mechanism 40. Alternatively, CPU 523 may turn off a switch or a relay that opens and closes the circuit connecting the inverter and the power source contained in the motor driver 515 of the drive substrate 510. Thus, the energization from the motor driver 515 to the drive mechanism 40 is shut off.

Since the robot controller 500 shuts off energization to the drive mechanism 40 after the drive mechanism 40 is stopped, for example, even if dew condensation occurs inside the robot 100, a short circuit will not occur in the motor 42 included in the drive mechanism 40. Therefore, the motor failure can be prevented. Further, the robot controller 500 re-energizes the drive mechanism 40 after the temperature of the measurement target has reached or exceeded the resume temperature. The resume temperature is desirably set at a temperature that does not cause dew condensation inside the robot 100. Since the drive mechanism 40 is energized after the temperature of the measurement target is equal to or higher than the resume temperature, failure of the motor can be prevented. Further, to prevent the occurrence of dew condensation, the housing constituting the main body 31 of the arm element may be formed to have double walls with an air layer or a heat insulation material in between.

### B2. Other Embodiment 2

In the embodiment, when the robot 100 is gripping a workpiece, the operation of the drive mechanism 40 is stopped while the robot 100 is gripping the workpiece. However, the CPU 523 of the robot controller 500 may control the robot 100 to release the workpiece being gripped by the robot 100 before stopping operation of the drive mechanism 40. The timing before stopping operation of the drive mechanism 40 is the timing after step S14 and before step S15 in FIG. 7. In this case, the CPU 523 first stores the current position of the robot 100 in the memory 521. The CPU 523 causes the robot 100 to carry the workpiece to a preset position and to unload the workpiece at that position. Subsequently, the CPU 523 moves the robot 100 to a standby position. Thereafter, the CPU 523 can stop the operation of the drive mechanism 40. For example, the CPU 523 may control the robot 100 as described above by executing an operation program for interrupting the operation stored in the memory 521 in advance.

In addition, when all the temperatures of the measurement target outputs from the temperature control device 300 are within the allowable range, the CPU 523 reads out the position of the robot 100 before the interruption from the memory 521 and moves the robot 100 to that position. For example, the CPU 523 may control the robot 100 as follows by executing an operation program for resuming operation stored in the memory 521 in advance. Thereafter, the CPU 523 causes the robot 100 to resume working.

For example, a state in which the robot 100 is gripping a low-temperature workpiece has a larger heat capacity than a state in which the robot 100 is not gripping a low-temperature workpiece. In other words, temperature rise rate per unit of time due to heating of the drive mechanism 40 is greater a state in which the robot 100 is not gripping a low-temperature workpiece than a state in which the robot 100 is gripping a low-temperature workpiece. Since the robot 100 is forced to release the workpiece before operation of the drive mechanism 40 is stopped, the temperature rise rate per unit time due to heating of the drive mechanism 40 can be greater than when the robot 100 is gripping the workpiece. Therefore, the drive mechanism 40 can be heated efficiently.

### B3. Other Embodiment 3

In the embodiment, an example in which the same target temperature is set for the six drive mechanisms 40 has been described. However, a target value, which is the target temperature, may be set for each of the six drive mechanisms 40. In this case, the upper limit value and the lower limit value, which define the allowable range of the temperature, are set for each of the six drive mechanisms 40. The CPU 523 sets target temperatures for each of the six drive mechanisms 40 in the temperature control device 300. The temperature control device 300 adjusts the temperature of each of the drive mechanisms 40 according to the target temperature of each of the drive mechanisms 40.

Advantages of having different target temperatures for the six drive mechanisms 40 will be explained. First, in the robot 100, the motor capacities of the motors 42 of the drive mechanisms 40 in each of the arm elements are different. The motor 42 located on the base side of the arm 20 has a larger motor capacity than the motor 42 located on the tip end side of the arm 20. The motor 42 located on the base side of the arm 20 is, for example, the motor 42 that drives the joint J1, which is comprised by the connection portion between the base 10 and the arm elements 21. The motor 42 located on the tip end side of the arm 20 is, for example, a motor 42 that drives the joint J6. The reason for the different motor capacities is as follows. The motor 42 that is located on the base side of the arm 20 supports the other arm elements. On the other hand, the motor 42 that is located on the tip end side of the arm 20 does not need to support the other arm elements.

If the six motors 42 perform about the same amount of work, the heating amount per unit of time by the motors 42 is proportional to the motor capacity of the motors 42. Therefore, the motor 42 that is located on the tip end side of the arm 20 generates less heating amount per unit of time than the motor 42 that is located on the base side of the arm 20. Therefore, even if the arm element on the tip end side and the arm element on the base side are heated in the same manner, the temperature rise rate per unit of time due to heating of the arm element on the tip end side is smaller than that of the arm element on the base side. For this reason, the target temperature of the arm element on the tip side may be set higher than that of the arm element on the base side.

If the motor capacities of the six motors 42 are comparable, the heating amount per unit of time of the motor 42 itself is proportional to the work amount per unit of time of the motor 42. For example, assume that a workload of the motor 42 located on the base side of the arm 20 is greater than that of the motor 42 located on the tip end side of the arm 20. In this case, the temperature rise rate per unit of time due to heating of the arm element on the base side is greater than that of the arm element on the tip end side. For this reason, the target temperature of the arm element on the tip side may be set higher than that of the arm element on the base side.

Further, for example, if an object to be gripped by the robot 100 is a low-temperature object such as frozen food, the heat capacity of the arm element 26 closest to the end effector 70 will be larger than the heat capacities of the other arm elements. In this case, the temperature rise rate per unit of time due to the heating of the arm element 26 is smaller than that of the other arm elements. Therefore, the target temperature of the arm element 26 may be set to be higher than the target temperatures of the other arm elements.

The allowable range of the measured temperature for each of the drive mechanisms 40 is equal to or above the lower limit value and is equal to or below the upper limit value, which is set for that drive mechanism 40. The stop temperature, which is a criterion for determining whether or not to stop the operation of the drive mechanism 40, may be set separately for each of the measurement targets. Depending on the position where the arm element is located and the size of the arm element, the number of factors affecting the temperature drop of the arm element may differ for each arm element. Therefore, it may be desirable to set separately the stop temperatures. In such a case, the operation of the drive mechanism 40 can be stopped appropriately compared to a situation where the same stop temperature is set for the plurality of drive mechanisms 40.

In addition, the resume temperature, which is a criterion for determining whether or not to resume the operation of the drive mechanism 40, may be set separately for each of the measurement targets. Depending on the position where the arm element is located and the size of the arm element, the number of factors affecting the temperature rise of the arm element may differ for each arm element. Therefore, it may be desirable to set separately the resume temperatures. In such a case, the operation of the drive mechanism 40 can be resumed appropriately compared to a situation where the same resume temperature is set for the plurality of drive mechanisms 40.

### B4. Other Embodiment 4

In the embodiment, the operation of the drive mechanism 40 is stopped when the temperature of at least one drive mechanism 40 falls below the lower limit value, and the operation of all the drive mechanisms 40 is resumed when the temperatures of all the drive mechanisms 40 are equal to or higher than the lower limit value. That is, the stop temperature, which is the criterion for determining whether or not to stop the operation of the drive mechanism 40, and the resume temperature, which is the criterion for determining whether or not to resume the operation of the drive mechanism 40, are the same. However, the stop temperature and the resume temperature may be set to be differently. For example, the resume temperature can be set higher than the stop temperature. When the operation of the drive mechanism 40 is stopped, the heating amount of the motor 42 is reduced compared to when the drive mechanism 40 is in operation. By resuming the operation of the drive mechanism 40 after sufficient heating, the robot 100 can operate smoothly.

### B5. Other Embodiment 5

In the embodiment, an example was described in which the operations of the six drive mechanisms 40 of the robot 100 are stopped when the temperature of at least one drive mechanism 40 among the six drive mechanisms 40 is below the lower limit value. In the embodiment, the robot 100 is installed in a low-temperature environment. However, in some cases, the ambient temperature of the robot 100 is lower than the temperature of a normal temperature environment, but not as high as the temperature of the low-temperature environment. Depending on the environment around the robot 100, the operation of the six drive mechanisms 40 may be stopped when the temperatures of at least N of the six drive mechanisms 40 of the robot 100 (N is an integer higher than or equal to 2) is below the lower limit value. Even in this configuration, hardening of the lubricant and dew condensation inside the robot arm can be suppressed during operation of the robot 100. Accordingly, it is possible to suppress an unnecessary increase in power consumption of the robot arm operation due to hardening of the lubricant and failure of the motor that drives the joints due to dew condensation inside the robot arm.

In addition, an example has been described in which the operations of the six drive mechanisms 40 are resumed when all of the six drive mechanisms 40 are above or equal to the lower limit value after the drive mechanisms 40 is stopped. However, in some cases, the ambient temperature of the robot 100 is lower than the temperature of a normal temperature environment, but not as high as the temperature of the low-temperature environment. Depending on the environment around the robot 100, after the drive mechanisms 40 are stopped, the operation of the six drive mechanisms 40 may be resumed if the determined resume conditions are met. For example, even if the temperature of some of the six drive mechanisms 40 is below the lower limit value, the resume condition may be assumed to be satisfied if the difference between the lower limit value and the temperature of the drive mechanism is within a preset range. The preset range is a range in which temperature differences between the lower limit value and the temperature of the drive mechanism can be considered small. If the difference between the lower limit value and the temperature of the drive mechanism 40 is small, then it can be assumed that it will not take a long time for the temperature of the drive mechanism 40 to reach the lower limit value after the drive mechanism 40 resumes the operation.

### B6. Other Embodiment 6

In the embodiment, an example has been described in which all of the six drive mechanisms 40 are measurement targets. However, the measurement target may be some of the six drive mechanisms 40. Since the robot 100 has six joints, it would be considered difficult to determine the temperature of the arm 20 if the measurement target is only one drive mechanism 40. Therefore, it is desirable that at least two drive mechanisms 40 are the measurement targets. For example, in the robot 100 shown in FIG. 1, each of the drive mechanisms 40 that drive the joints J1, J2, J4, and J5 will be the measurement target. In this case, the temperature sensors 310 and the heaters 320 are provided in the vicinity of the drive mechanisms 40 that are the measurement targets. The heaters 320 are provided and the temperature sensors 310 are not provided in the vicinity of the drive mechanisms 40 that are not the measurement targets.

In this case, as in the embodiment, the operation of all drive mechanisms 40 is stopped when the temperature of the measurement targets, as measured by the temperature sensors 310, falls below the stop temperature. After the operation of the drive mechanism 40 is stopped, when the temperatures of the measurement targets measured by the temperature sensors 310 reach or exceed the resume temperature, the operation of all the drive mechanisms 40 is resumed. In addition, the stop temperature and the resume temperature may be set separately for each measurement target. The stop temperature and the resume temperature may be the same or different. Alternatively, the same stop temperature and the same resume temperature may be set for the measurement targets.

### B7. Other Embodiment 7

The robot controller 500 may also calculate a temperature drop speed based on the measured temperature of the drive mechanism 40 over a set period of time. In this specification, the temperature drop speed represents the degree to which the temperature of the drive mechanism 40 drops over time. If the temperature drop speed is faster than the preset speed, the robot controller 500 changes the stop temperature of the drive mechanism 40 to a value that is higher than the currently set stop temperature value and that is lower than the current temperature of the drive mechanism 40. Alternatively, if the temperature drop speed is faster than the preset speed, the robot controller 500 can change the stop temperature of the drive mechanism 40 to a value higher than the currently set stop temperature value. If the current temperature of the drive mechanism 40 is not taken into account, situations can be envisaged where the newly set stop temperature will be higher than the current temperature of the drive mechanism 40. If such a situation arises, the robot controller 500 immediately stops the operation of the robot 100.

For example, it will be assumed that when the temperature of the drive mechanism 40 is dropping rapidly, the drive mechanism 40 is stopped after the temperature drops below the stop temperature. In this case, situations can be envisaged where the temperature of the drive mechanism 40 at the time of stopping the operation of the drive mechanism 40 is significantly lower than the stop temperature. In this case, situations can be envisaged where operation of the drive mechanism 40 malfunctions before operation of the drive mechanism 40 is stopped. Therefore, when the temperature drop speed is above or equal to the preset speed, the stop temperature is changed to a higher value than the current value, and the operation of the drive mechanism 40 is stopped before the temperature of the drive mechanism 40 reaches the stop temperature set before the change. As a result, the operation of the drive mechanism 40 can be prevented from causing defects.

Although an example of a six axis vertically articulated robot is described in the embodiment, the robot 100 may be a SCARA robot.

The present disclosure is not limited to the above described embodiments, and can be realized by various configurations without departing from the scope of the present disclosure. For example, the technical features in the embodiments corresponding to the technical features in the aspects described in the summary of disclosure can be replaced or combined as appropriate in order to solve some or all of the problems described above or in order to achieve some or all of the effects described above. In addition, if the technical features are not described as essential in this specification, the technical features can be appropriately deleted.

### C. Other Embodiments

(1) According to an aspect of the present disclosure, a control method for controlling a robot arm in a robot system that includes a robot arm having a plurality of joints and a plurality of drive sections that drive each of said plurality of joints, a controller that controls said robot arm, and a temperature control section that controls the temperature of said robot arm, is provided. The control method includes a measuring step of measuring a temperature of a measurement target drive section from among the plurality of drive sections, at a predetermined time interval using the temperature measurement section included in the temperature control section; a heating step of heating the plurality of drive sections by the heating sections included in the temperature control section; a stopping step of the controller stopping operation of the plurality of drive sections when the temperature of measurement target falls below a preset stop temperature; and a resuming step of the controller, after performing the stopping step, resuming operation of the plurality of drive sections when the temperature of measurement target is equal to or higher than a preset resume temperature. According to the above aspect, the operation of the plurality of drive sections are stopped when the temperature of the measurement target of the drive sections falls below the stop temperature. Therefore, the operation of the robot arm is not continued while the temperature of the drive sections of the robot arm remains low. Therefore, it is possible to suppress hardening of the lubricant, dew condensation inside the arm, and the like during the operation of the robot arm. Accordingly, it is possible to suppress an unnecessary increase in power consumption of the robot arm operation due to hardening of the lubricant and failure of the motor that drives the joints due to dew condensation inside the robot arm.

(2) In the control method of the above aspect, in the stopping step, the controller may stop operation of the plurality of drive sections and then shut off energization to the plurality of drive sections. According to the above aspect, after the operation of the drive sections is stopped, the energization to the drive sections is shout off so that, for example, even if when dew condensation occurs in the robot arm, a short circuit will not occur in the motor included in the drive section, and the motor can be prevented from breaking down.

(3) In the control method of the above aspects, in the stopping step, the controller may control the robot arm to release a workpiece that the robot is gripping before stopping operation of the plurality of drive sections, and then stops operation of the plurality of drive sections. For example, a state in which the robot arm is gripping a low-temperature workpiece has larger heat capacity than a state in which the robot arm is not gripping a low-temperature workpiece. In other words, the temperature rise rate per unit of time due to heating of the drive section is smaller in the state where the robot arm is gripping a low-temperature workpiece than in the state where the robot arm is not gripping a low-temperature workpiece. According to the above aspect, because the robot arm releases the workpiece being gripped by the robot arm before the drive section stops operating, the temperature rise rate per unit of time due to heating the drive section can be greater than that of the robot arm gripping a low-temperature workpiece.

(4) In the control method of the above aspects, the measurement target is at least two of the plurality of drive sections. In the stopping step, the controller may stop operation of the plurality of drive sections when the temperature of at least one of the measurement targets is below the stop temperature. According to the above aspect, when the temperature of at least one of the plurality of drive sections of the robot arm is below the stop temperature, the operation of the plurality of drive sections is stopped. Therefore, it is possible to more certainly suppress the occurrence of hardening of lubricant, dew condensation inside the robot arm, and the like, during the operation of the robot arm.

(5) In the control method of the above aspects, in the resuming step, the controller, after performing the stopping step, may resume operation of the plurality of drive sections when all temperatures of the measurement targets are equal to or higher than the resume temperature. According to the above aspect, the operations of the drive sections will not be resumed until the temperature of all the drive sections of the robot arm is equal to or higher than the resume temperature. Therefore, it is possible to more certainly suppress the occurrence of hardening of lubricant, dew condensation inside the robot arm, and the like, during the operation of the robot arm.

(6) In the control method of the above aspects, the stop temperature may be set separately for each of the measurement targets. For example, depending on the position where the arm element is located and the size of the arm element, the number of factors affecting the temperature drop of the arm element may differ for each arm element. According to the above aspect, since the stop temperature is set separately, the operation of the drive section can be stopped more appropriately than in the case where the same stop temperature is set for the measurement target.

(7) In the control method of the above aspects, the resume temperature may be set separately for each of the measurement targets. For example, depending on the position where the arm element is located and the size of the arm element, the number of factors affecting the temperature rise of the arm element may differ for each arm element. According to the above aspect, since the resume temperature is set separately, the operation of the drive sections can be resumed appropriately compared to the case where the same resume temperature is set for the measurement targets.

(8) In the control method of the above aspects, the controller may calculate a temperature drop speed based on the measured temperature of the drive section, which is measured by the temperature measurement section during the set period, and when the temperature drop speed is equal to or higher than a preset speed, the controller may change the stop temperature that was set for the drive section to a value higher than the currently set value. According to the above aspect, for example, assume that when the temperature of the drive section is rapidly decreasing, the operation of the drive section is stopped after the temperature of the drive section falls below the stop temperature. In this case, it is assumed that the temperature of the drive section at the time of stopping the operation of the drive section is significantly lower than the stop temperature. In this case, it is assumed that a malfunction in the operation of the drive section may occur before the operation of the drive section is stopped. Therefore, when the temperature drop speed is equal to or higher than the preset speed, the stop temperature is changed to a higher value than the current value, and the operation of the drive section is stopped before the temperature of the drive section reaches the stop temperature set before the change. As a result, it is possible to prevent problems from occurring in the operation of the drive section.

What is claimed is:

1. A control method for controlling a robot arm in a robot system that includes:
a robot arm having a plurality of joints and a plurality of drive sections that drive each of the plurality of joints,
a controller that controls the robot arm, and
a temperature control section that has a temperature measurement section and a heating section and that adjust a temperature of the robot arm,
the control method comprising:
a measuring step of measuring a temperature of a measurement target drive section from among the plurality of drive sections, at a predetermined time interval using the temperature measurement section;
a heating step of heating the plurality of drive sections using the heating section;
a stopping step of the controller stopping operation of the plurality of drive sections when the temperature of measurement target falls below a preset stop temperature; and
a resuming step of the controller, after performing the stopping step, resuming operation of the plurality of drive sections when the temperature of measurement target is equal to or higher than a preset resume temperature.

2. The control method according to claim 1, wherein
in the stopping step, the controller stops operation of the plurality of drive sections and then shuts off energization to the plurality of drive sections.

3. The control method according to claim 1, wherein
in the stopping step, the controller controls the robot arm to release a workpiece that the robot is gripping before stopping operation of the plurality of drive sections, and then stops operation of the plurality of drive sections.

4. The control method according to claim 1, wherein
the measurement target is at least two of the plurality of drive sections and
in the stopping step, the controller stops operation of the plurality of drive sections when the temperature of at least one of the measurement targets is below the stop temperature.

5. The control method according to claim 4, wherein
in the resuming step, the controller, after performing the stopping step, resumes operation of the plurality of drive sections when all temperatures of the measurement targets are equal to or higher than the resume temperature.

6. The control method according to claim 4, wherein
the stop temperature is set separately for each of the measurement targets.

7. The control method according to claim 4, wherein
the resume temperature is set separately for each of the measurement targets.

8. The control method according to claim 1, wherein
the controller calculates a temperature drop speed based on the measured temperature of the drive section, which is measured by the temperature measurement section during a set period, and when the temperature drop speed is equal to or higher than a preset speed, the controller changes the stop temperature that was set for the drive section to a value higher than the currently set value.
